(19) United States
(12) Patent Application Publication
(10) Pub. No.: US 2022/0299652 A1
(43) Pub. Date: Sep. 22, 2022

(54) GNSS STANDARD POINT POSITIONING METHOD BASED ON SPHERICAL HARMONICS

(71) Applicant: SHANDONG UNIVERSITY OF SCIENCE AND TECHNOLOGY, Qingdao (CN)

(72) Inventors: Jinyun GUO, Qingdao (CN); Hengyang GUO, Qingdao (CN); Zhouming YANG, Qingdao (CN); Yunpeng XING, Qingdao (CN); Xin LIU, Qingdao (CN); Qiaoli KONG, Qingdao (CN)

(21) Appl. No.: 17/730,567

(22) Filed: Apr. 27, 2022

Related U.S. Application Data
(63) Continuation of application No. PCT/CN2021/123845, filed on Oct. 14, 2021.

(30) Foreign Application Priority Data
Mar. 17, 2021 (CN) 202110283670.9

(51) Int. Cl. G01S 19/07; G01S 19/25; G01S 19/08

(52) U.S. Cl. CPC G01S 19/072; G01S 19/258; G01S 19/08; G01S 19/073

(57) ABSTRACT

The present invention belongs to the field of satellite navigation and positioning technology, more specifically a GNSS standard point positioning method based on the spherical harmonics. The method achieves the calculation of the station position with GNSS observations and satellite broadcast ephemeris. In this method, spherical harmonics are used to describe the errors related to the elevation and azimuth angle between the station and the satellite, including tropospheric delay errors and ionospheric delay errors. Compared with the existing methods of correcting the tropospheric delay by using empirical models, the method in the present invention can obtain the position information of survey points quickly and with high efficiency and present advantages such as a simple practical performance, a convenient data process and high calculation efficiency.

### CROSS-REFERENCE TO RELATED APPLICATIONS

This application is a continuation of International Application No. PCT/CN2021/123845 with a filling date of Oct. 14, 2021, designating the United states, now pending, and further claims to the benefit of priority from Chinese Application No. 202110283670.9 with a filing date of Mar. 17, 2021. The content of the aforementioned applications, including any intervening amendments thereto, are incorporated herein by reference.

### TECHNICAL FIELD

The present invention belongs to the field of satellite navigation and positioning technology, more specifically a GNSS standard point positioning method based on the spherical harmonics.

### BACKGROUND

The GNSS standard point positioning method refers to the positioning method of independently measuring the three-dimensional coordinate of one GNSS receiver under the earth-centered earth-fixed coordinate system through the resection method according to the satellite location and the satellite clock bias at the observation moment given by the satellite ephemeris and the distance between the satellite and the GNSS receiver.

The method using the satellite position and satellite clock bias provided by the broadcast ephemeris and the pseudo-range observations is called a standard point positioning. The limitation to the broadcast ephemeris and the pseudo-range and the failure to completely eliminate the influence of each error in its mathematical mode cause that generally the accuracy of the standard point positioning can only reach the meter level. Therefore, the standard point positioning is mainly used for low-precision positioning areas such as navigation positioning and resource investigation and survey. The method using the precise ephemeris and precise satellite clock bias data and based on the phase observations is called precise point positioning, whose accuracy can reach the centimeter level.

Among the three types of error sources that influence results of the standard point positioning, the error (mainly refers to the ionospheric delay error and the tropospheric delay error) associated with signal propagation cannot be well-modeled well, which means the influence on the positioning is huge.

The single-frequency receiver needs a model to correct the ionospheric delay error; the dual-frequency receiver can eliminate the influence of the ionospheric delay error through the linear combination method; as the nature of the troposphere is nondispersive, the tropospheric delay error cannot be eliminated through the linear combination method of dual-frequency observations, which means its influence on the positioning accuracy cannot be ignored.

The tropospheric delay is divided into two parts of the dry delay and the wet delay. In a conventional positioning calculation strategy, the dry delay in a zenith direction is calculated by the tropospheric delay model and it is mapped to the propagation path through a mapping function; and the wet delay in a zenith direction is calculated as an unknown parameter and it is mapped to the propagation path through a mapping function. In the GNSS measurement, the tropospheric delay model or method includes Saastamoinen model, UNB3 model or Meteorological Element Method etc.

Following problems exist in the above three correction methods for the tropospheric delay: despite a relatively high precision, the need to acquire the actually measured meteorological data limits the application of Saastamoinen model; UNB3 model does not need to input actually measured meteorological data, but UNB3 model has a limited accuracy; in the meteorological element method, an external meteorological equipment is needed to collect data but different equipments share different accuracies and the heavy and expensive equipment increases the workload of field data collection; at the same time the meteorological element method also lowers the work efficiency of the single point positioning, which means it is very difficult to provide the data required in a all-weather single point positioning.

The above three correction methods for the tropospheric delay construct various models to meet requirements of correcting the tropospheric delay under different conditions, which means the field and indoor measurement workload will be increased and the data processing efficiency will be lowered if the practicality and universality are taken into consideration. In addition, the single point positioning usually adopts an empirical model for the correction on the tropospheric delay and the parameter estimation for such empirical model always adopts an empirical value, which means it is difficult to comply with the parameter estimation in the actual single point positioning.

### SUMMARY OF THE INVENTION

The present invention aims to provide a GNSS standard point positioning method based on the spherical harmonics so as to perform the standard point positioning fast, effectively and accurately.

The present invention adopts the following technical solution to achieve the above target:

A GNSS standard point positioning method based on the spherical harmonics that achieves the calculation of spatial position of the station and further achieves GNSS standard point positioning by describing error terms including the tropospheric delay error and the ionospheric delay error and related to the elevation angle and the azimuth angle between the station and the satellite through the spherical harmonics and using GNSS observation data and satellite broadcast ephemeris.

The present invention possesses the following advantages:

Compared with the existing method of correcting the tropospheric delay by using the empirical model, the method in the present invention can obtain the position information of survey points quickly and with high efficiency and present advantages such as a simple practical performance, a convenient data process and high calculation efficiency.

### BRIEF DESCRIPTION OF DRAWINGS

FIG. 1 is a flow diagram of the GNSS standard point positioning based on the spherical harmonics in Embodiment 1 of the present invention;

FIG. 2 is a flow diagram of the GNSS precise single point positioning based on the spherical harmonics in Embodiment 2 of the present invention;

FIG. 3 is a result statistical chart of the GNSS standard point positioning method on the spherical harmonics in embodiments of the present invention;

FIG. 4 is a result statistical chart of the GNSS precise single point positioning method on the spherical harmonics in embodiments of the present invention.

### DETAILED DESCRIPTION OF PREFERRED EMBODIMENTS

Now each embodiment in the present application is further described in combination with the drawings.

### Embodiment 1

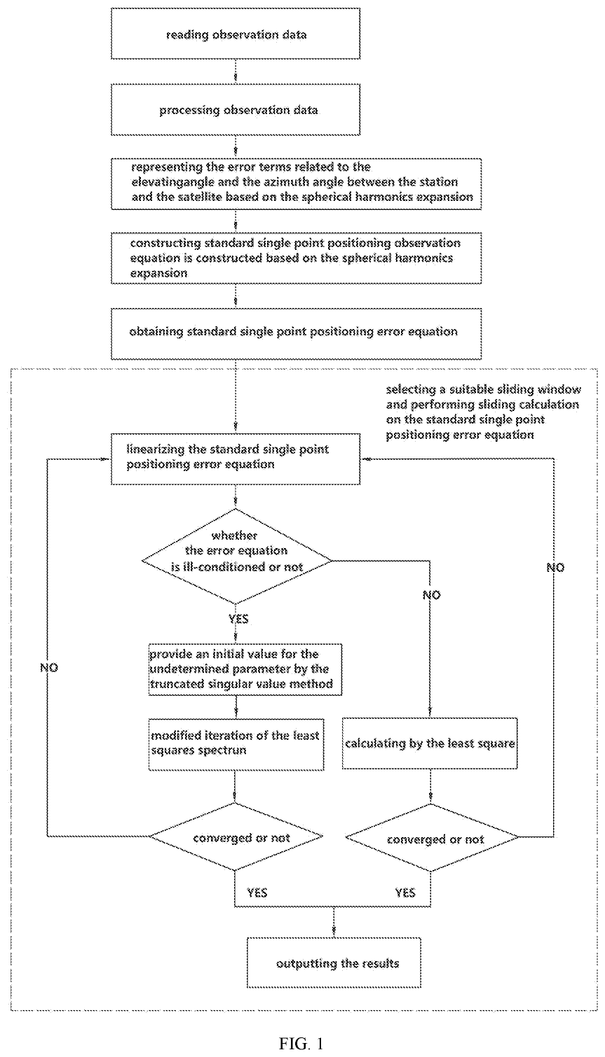

The present embodiment describes a GNSS standard point positioning method based on the spherical harmonics. As shown in FIG. 1, the GNSS standard point positioning method based on the spherical harmonics can realize the calculation of the position of the station, and further realize the GNSS standard point positioning according to the position of the satellite in space and the satellite clock error at the moment of observation given by the satellite ephemeris, and the distance from the satellite to the GNSS receiver measured by the GNSS receiver, the spherical harmonics are used to describe the errors related to the elevation and azimuth angle between the station and the satellite, and the GNSS standard point positioning method includes the following steps:

I.1. establishing a standard point positioning observation equation with a pseudo-range.

Achieving the standard point positioning, reading the observation data and the broadcast ephemeris, processing the pseudo-range observations and calculating errors including the satellite ephemeris error and the satellite clock bias and not related to or not closely related to the elevation angle and the azimuth angle between the station and satellite. As the degree of the satellite ephemeris error is substantially the same with the degree of the error for the standard point positioning, broadcast ephemeris can be used in the standard point positioning of low precision, which means the satellite ephemeris error in the standard point positioning can be ignored.

In the standard point positioning, the satellite position corresponding to each epoch is obtained by the interpolation calculation of the broadcast ephemeris; the satellite clock bias is obtained by the satellite clock bias provided by the broadcast ephemeris, wherein generally the satellite clock bias tₛ is obtained by fitting one polynomial: tₛ=a₀+a₁(tᵢ−t₀)+a₂(tᵢ−t₀)², a₀, a₁ and a₂ are respectively the clock bias, the clock drift and frequency drift coefficient of the clock and can read in a navigation message; t₀ is the reference moment for a polynomial to calculate the satellite clock bias, tᵢ represents the single receiving moment, i.e., the data recording moment.

A ground receiver clock always adopts a quartz clock and the ground receiver has a precision lower than the satellite clock. As changes to the clock bias are irregular and cannot be well fitted by a polynomial, the clock bias tᵣ of the receiver is estimated as an parameter.

The established observation equation for the standard point positioning performed by using the pseudo-range is shown as equation (1);

ρᵢ^{j}=Rᵢ^{j}+c·[(tᵣ)ᵢ−(tₛ)ᵢ^{j}]+(ρₜᵣₒₚ)ᵢ^{j}+(ρᵢₒₙ)ᵢ^{j}+ε_{ρ} (1)

where i represents a number of epoch i, j represents a satellite number; ρ represents a pseudo-range, ρᵢ^{j} represents the pseudo-range of a satellite j at epoch i; Rᵢ^{j} represents the euclidean distance between the location of a receiver and the location of the satellite j at epoch i; c represents the velocity of light; tᵣ represents a clock bias of a receiver, (tᵣ) represents the clock bias of a receiver at epoch i; tₛ represents a satellite clock bias, (tᵣ)ᵢ represents the clock bias of the satellite j at epoch i; (ρₜᵣₒₚ)ᵢ^{j} represents the tropospheric delay error of a signal transmission path for the satellite j at epoch i; (ρᵢₒₙ)ᵢ^{j} represents the ionospheric delay error of a signal transmission path for the satellite j at epoch i; ε_{ρ} represents a residual of pseudo-range observation; the three-dimensional coordinate at the moment of observing the satellite j at epoch i is defined as (Xᵢ^{j}, Yᵢ^{j}, Zᵢ^{j}), the approximate coordinate of the station is (X₀, Y₀, Z₀), then the euclidean distance (Rᵢ^{j})₀ between the satellite and the approximate location of the station is represented as:

(Rᵢ^{j})₀=\sqrt{(X₀−Xᵢ^{j})²+(Y₀−Yᵢ^{j})²+(Z₀−Zᵢ^{j})²}.

Types of the GNSS pseudo-range observations include the single frequency observation data and the dual-frequency observation data. If the GNSS receiver performing the standard point positioning is a dual-frequency receiver, then the ionospheric delay error is eliminated through the combination of the dual-frequency ionosphere and the combination method is as follows:

$$ρ = \frac{{f}_{1}^{2}}{{f}_{1}^{2} - {f}_{2}^{2}} {ρ}_{1} - \frac{{f}_{2}^{2}}{{f}_{1}^{2} - {f}_{2}^{2}} {ρ}_{2} ;$$

ρ is the observation value of the pseudo-range ionosphere combination; f₁, f₂ are frequencies corresponding to the observation value; ρ₁, ρ₂ respectively represent the pseudo-ranges corresponding to two frequencies. When the observation data is a dual-frequency observation value, in equation (1), the first-order principal term of the ionospheric delay error is eliminated through the combination of the dual-frequency ionosphere, the term (ρᵢₒₙ)ᵢ^{j} of the ionospheric delay error is 0. At this time, in the observation equation for the standard point positioning in the present Embodiment 1, the spherical harmonics is mainly used to represents the tropospheric delay error term, the spherical harmonics has an order that is different from the observation equation established by the single frequency pseudo-range.

I.2. in the standard point positioning, the tropospheric delay error and the ionospheric delay error are all a single delay error produced when the satellite single passes through the atmosphere and all related to the satellite signal propagation; as the propagation path of the satellite single is related to the positions of the station and the satellite, the elevation angle and the azimuth angle between the station and satellite can be calculated by the station coordinate and the satellite position, error terms including the tropospheric delay error and the ionospheric delay error and related to the elevation angle and the azimuth angle between the station and the satellite can be represented by the spherical harmonics to eliminate or weaken at a maximum order their influence on the results of the standard point positioning. The observation equation represents for the standard point positioning based on the spherical harmonics:

$${ρ}_{i}^{j} = {( {R}_{i}^{j} )}_{0} + c \cdot [ {( {t}_{r} )}_{i} - {( {t}_{s} )}_{i}^{j} ] + {\sum }_{n = 0}^{Nmax} {\sum }_{m = 0}^{n} {P}_{n m} ( cos ( {e}_{i}^{j} ) ) [ {C}_{n m} cos ( m ( {α}_{i}^{j} ) ) + {S}_{n m} sin ( m ( {α}_{i}^{j} ) ) ] + {ε}_{ρ} \qquad ( 2 )$$

where n is the degree of the spherical harmonics, m is the order of the spherical harmonics, Nmax is the maximum order of the spherical harmonics; Pₙₘ (cos (eᵢ^{j})) represents the Associated Legendre polynomials in order n and order m; Cₙₘ and Sₙₘ represent coefficients of the spherical harmonics function model in order n and order m, Cₙₘ and Sₙₘ are the parameter of the spherical harmonics; eᵢ^{j} represents the elevation angle between the station and the satellite j at epoch i and aᵢ^{j} represents the azimuth angle between the station and the satellite j at epoch i of observation;

The observation equation for the standard point positioning based on the spherical harmonics represented by equation (2) does not relate to the correction model of the tropospheric delay error, which means there is no need to take the application issues of different models in different areas. Moreover, the coefficient of the spherical harmonics is calculated as the parameter in the present embodiment to correct error terms mainly including the tropospheric delay error and related to the elevation angle and the azimuth angle between the station and the satellite, which means there is no need to consider the meteorological information and it presents more universality. For the convenience of representing the spherical harmonics, take:

$${T}_{1}^{j} = {\sum }_{n = 0}^{Nmax} {\sum }_{m = 0}^{n} {P}_{n m} ( cos ( {e}_{i}^{j} ) ) [ {C}_{n m} cos ( m ( {α}_{i}^{j} ) ) + {S}_{n m} sin ( m ( {α}_{i}^{j} ) ) ] ;$$

The equation (2) is simplified as: ρᵢ^{j}(Rᵢ^{j})₀+c·[(tᵣ)ᵢ−(tₛ)ᵢ^{j}]+Tᵢ^{j}+ε_{ρ}(3)

The error equation (4) for the standard point positioning is obtained from the simplified observation equation (3) for the standard point positioning, the equation is as follows:

(v_{ρ})ᵢ^{j}=(Rᵢ^{j})₀+c·[(tᵣ)ᵢ−(tₛ)ᵢ^{j}]+Tᵢ^{j}−ρᵢ^{j} (4)

where v_{ρ} represents the correction value of the pseudo-range observations;

(vρ)ᵢ^{j} represents the correction value of the pseudo-range observations of satellite j at epoch i of observation.

I.3. the simplification process is performed based on the linearization expression obtained from the standard point positioning error equation (4), the sliding calculation is performed on the linearization expression of the standard point positioning error equation.

I.3.1. the Taylor series expansion is performed on the approximate coordinate (X₀, Y₀, Z₀) of the standard point positioning error equation (4) in the station and the first-order item is retained, and then the linearization expression obtained from the standard point positioning error equation is:

$${( {v}_{ρ} )}_{i}^{j} = {( {R}_{i}^{j} )}_{0} + \frac{{X}_{0} - {X}_{i}^{j}}{{( {R}_{i}^{j} )}_{0}} dX + \frac{{Y}_{{0}^{-}} {Y}_{i}^{j}}{{( {R}_{i}^{j} )}_{0}} dY + \frac{{Z}_{0} - {Z}_{i}^{j}}{{( {R}_{i}^{j} )}_{0}} dZ + \frac{\partial {T}_{i}^{j}}{\partial {C}_{n m}} d {C}_{n m} + \frac{\partial {T}_{i}^{j}}{\partial {S}_{n m}} d {S}_{n m} + {d ( {t}_{r} )}_{i} - c \cdot {( {t}_{s} )}_{i}^{j} - {ρ}_{i}^{j} \qquad ( 5 )$$

in equation (5),

$$\frac{{X}_{0} - {X}_{i}^{j}}{{( {R}_{i}^{j} )}_{0}} = {I}_{i}^{j} , \frac{{Y}_{0} - {Y}_{i}^{j}}{{( {R}_{i}^{j} )}_{0}} = {J}_{i}^{j} , \frac{{Z}_{0} - {Z}_{i}^{j}}{{( {R}_{i}^{j} )}_{0}} = {K}_{i}^{j} ,$$

$$\frac{\partial {T}_{i}^{j}}{\partial {C}_{n m}} = {P}_{n m} ( cos ( {e}_{i}^{j} ) ) cos ( m ( {α}_{i}^{j} ) ) , \\ \frac{\partial {T}_{i}^{j}}{\partial {S}_{n m}} = {P}_{n m} ( cos ( {e}_{i}^{j} ) ) sin ( m ( {α}_{i}^{j} ) ) ;$$

$${P}_{n m} ( cos ( {e}_{i}^{j} ) ) cos ( m ( {α}_{i}^{j} ) ) = {( {A}_{n m} )}_{i}^{j} , \\ {P}_{n m} ( cos ( {e}_{i}^{j} ) ) sin ( m ( {α}_{i}^{j} ) ) = {( {B}_{n m} )}_{i}^{j} .$$

Iᵢ^{j} represents the coefficient of the parameter dX calculated from the approximate coordinate of the station and coordinate of the satellite j at epoch i, the parameter dX is the correct value of the approximate coordinate X₀ of the station; Jᵢ^{j} represents the coefficient of the parameter dY calculated from the approximate coordinate of the station and coordinate of the satellite j at epoch i, the parameter dY is the correct value of the approximate coordinate Y₀ of the station; Kᵢ^{j} represents the coefficient of the parameter dZ calculated from the approximate coordinate of the station and coordinate of the satellite j at epoch i, the parameter dZ is the correct value of the approximate coordinate Z₀ of the station; (Aₙₘ)ᵢ^{j} represents the coefficient of the parameter Cₙₘ of the spherical harmonics calculated from the approximate coordinate of the station and coordinate of the satellite j at epoch i; (Bₙₘ)ᵢ^{j} represents the coefficient of the parameter Sₙₘ of the spherical harmonics calculated from the approximate coordinate of the station and coordinate of the satellite j at epoch i; tᵣ represents the clock bias of the station receiver. As the clock bias of the station receiver cannot be well fitted by a polynomial, it is calculated as an parameter. When calculated as an parameter, dtᵣ has a coefficient of 1; d(tᵣ)ᵢ represents the parameter for the clock bias of the receiver in the station at epoch i.

The simplified linearization expression for the standard point positioning error equation is shown as equation (6);

(v_{ρ})ᵢ^{j}=Iᵢ^{j}dX+Jᵢ^{j}dY+Kᵢ^{j}dZ+d(tᵣ)+(Aₙₘ)ᵢ^{j}dCₙₘ+(Bₙₘ)ᵢ^{j}dSₙₘ−(w_{ρ})ᵢ^{j} (6)

in equation (6), i=1, 2, . . . , epoch, epoch represents the maximum epoch number of observation; (w_{ρ})ᵢ^{j} represents the constant term calculated from the pseudo-range of the satellite j at epoch i, the clock bias of the satellite j at epoch i and the euclidean distance between the approximate coordinate of the station and the satellite j at epoch i, wherein, (w_{ρ})ᵢ^{j}=ρᵢ^{j}−(Rᵢ^{j})₀+c·(tₛ)ᵢ^{j}.

It can be seen from equation (6) that there are observation equations in an amount of epoch×j at this time. But the parameter includes 3 position parameters (dX, dY, dZ), the receiver clock bias dtᵣ parameters in an amount of epoch and parameters Cₙₘ and Sₙₘ of the spherical harmonics in an amount of (Nmax+1)².

When the epoch is large enough, the optimum solutions for all unknown numbers can be obtained from the least squares. So, as long as the correction terms can be described, the amount of the observation equation can be increased through the manner of increasing the observation epoch to calculate the unknown parameters.

In order to ensure that the unknown parameter is estimated as the optimum solution, the present embodiment selects the suitable sliding window by the above analysis to perform sliding calculation on the linear representation (6) of the simplified standard point positioning error equation.

The sliding window is configured to select epochs in an amount of i and each epoch can observe up to satellites in an amount of j, the pseudo-ranges of all satellites under this sliding window consist of equations in an amount of imax, wherein, imax=i×j.

When the coefficient matrix of the standard point positioning error equation, the vector matrix of correction number for the pseudo-range, the constant term matrix and the parameter matrix to be estimated are respectively defined as B, V, L, X, then their expressions are respectively shown as:

$$B = [ \begin{matrix}{I}_{1}^{1} & {J}_{1}^{1} & {K}_{1}^{1} & 1 & 0 & ⋯ & 0 & {( {A}_{00} )}_{1}^{1} & {( {A}_{10} )}_{1}^{1} & ⋯ & {( {B}_{NmaxNmax} )}_{1}^{1} \\ {I}_{1}^{2} & {J}_{1}^{2} & {K}_{1}^{2} & 1 & 0 & ⋮ & 0 & {( {A}_{00} )}_{1}^{2} & {( {A}_{10} )}_{1}^{2} & ⋮ & {( {B}_{NmaxNmax} )}_{2}^{1} \\ ⋮ & ⋮ & ⋮ & ⋮ & ⋮ & ⋱ & ⋮ & ⋮ & ⋮ & ⋱ & ⋮ \\ {I}_{2}^{1} & {J}_{2}^{1} & {K}_{2}^{1} & 0 & 1 & ⋯ & 0 & {( {A}_{00} )}_{2}^{1} & {( {A}_{10} )}_{2}^{1} & ⋯ & {( {B}_{NmaxNmax} )}_{2}^{1} \\ ⋮ & ⋮ & ⋮ & ⋮ & ⋮ & ⋱ & ⋮ & ⋮ & ⋮ & ⋱ & ⋮ \\ {I}_{imax}^{j} & {J}_{imax}^{j} & {K}_{imax}^{j} & 0 & 0 & ⋯ & 1 & {( {A}_{00} )}_{imax}^{j} & {( {A}_{10} )}_{imax}^{j} & ⋯ & {( {B}_{NmaxNmax} )}_{imax}^{j}\end{matrix} ] ;$$

$$V = {[ \begin{matrix}{( {v}_{ρ} )}_{1}^{1} & {( {v}_{ρ} )}_{1}^{2} & ⋯ & {( {v}_{ρ} )}_{2}^{1} & ⋯ & {( {v}_{ρ} )}_{imax}^{j}\end{matrix} ]}^{T} ;$$

$$L = {[ \begin{matrix}- {( {w}_{ρ} )}_{1}^{1} & - {( {w}_{ρ} )}_{1}^{2} & ⋯ & - {( {w}_{ρ} )}_{2}^{1} & ⋯ & - {( {w}_{ρ} )}_{imax}^{j}\end{matrix} ]}^{T} ;$$

$$X = [ \begin{matrix}dX & dY & dZ & {( {dt}_{r} )}_{1} & ⋯ & {( {dt}_{r} )}_{i} & {C}_{00} & ⋯ & {C}_{NmaxNmax} & {{S}_{NmaxNmax} ]}^{T} .\end{matrix}$$

The linearization expression of the standard point positioning error equation (6) is expressed by one matrix form, as shown by equation (7);

V=BX−L (7)

When constructing the coefficient matrix B in equation (7), it only needs to calculate the coefficients for each parameter (position parameter, station receiver clock bias parameter and parameters of the spherical harmonics) through simple mathematic calculation, wherein the calculation process is simple, the construction of the error equation is fast and the achievement of the standard point positioning is effective. At present, as error terms including the tropospheric delay error and related to the elevation angle and the azimuth angle between the station and the satellite cannot be corrected by a model precisely, it is an excellent way to solve it as the parameter in reference to receiver clock bias parameters for the station. The GNSS standard point positioning method based on the spherical harmonics is proposed on this idea and the coefficient of spherical harmonics is directly calculated in the standard point positioning equation by representing error terms related to the elevation angle and the azimuth angle between the station and the satellite with the spherical harmonics.

The least square of the unknown parameter X is estimated as:

X=(B^{T}PB)⁻¹B^{T}PL (8)

In equation (8), P is the unit weighting matrix.

I.3.2. if the coefficient matrix B of the standard point positioning error equation is well-conditioned, the solution to the unknown parameter calculated from equation (8) is the optimum unbiased estimation. When the coefficient matrix B is ill-conditioned, what is calculated from the least square is no longer the optimum solution.

Therefore, firstly a judgment is performed to determine where the coefficient matrix B in the standard point positioning error equation is ill-conditioned or not, if the judgment determines that the coefficient matrix B is ill-conditioned, then step I.3.3 is executed; otherwise, if the coefficient matrix B is determined as well-conditioned, the step I.3.4 is executed

The present embodiment calculates the conditional number of the coefficient matrix B, sets the empirical threshold value for the conditional number and compares the conditional number with the empirical threshold value, when the conditional number is greater than the empirical threshold value, the error equation (7) is determined as ill-conditioned, otherwise the error equation (7) is determined as well-conditioned.

I.3.3. in order to solve the ill-conditioned problem of the error equation, the present embodiment proposes a method using the truncated singular value decomposition to provide an initial value for the parameter X for the spectrum corrected iteration equation of the least-squares and calculates the value of the parameter based on the spectrum corrected iteration equation of the least-squares. The principle of truncated singular value method is to calculate the mean value of singular values in matrix S and take this mean value as the threshold value of the truncated singular value; the singular value less than the threshold value is screened out and is processed zero out. As the truncated singular value decomposition method transforms the least square method of the equation into the direct solution, an excessive deviation of the solution to the ill-conditioned equation from the real solution is avoided, which effectively solves the ill-conditioned problem for the coefficient matrix B in the error equation.

It is assumed that the coefficient matrix B∈R^{n×m}, R^{n×m} represents the real matrix of n rows and m columns; then the singular value decomposition of the coefficient matrix B is:

B=USV^{T} (9)

In equation (9), U∈n×n, V∈m×m, U and V are all orthogonal matrixes, S∈n×m is a diagonal matrix;

The truncated singular value matrix Bₖ of the coefficient matrix B∈R^{n×m} is defined as:

$${B}_{k} ≡ {US}_{k} {V}^{T} = {\sum }_{i = 1}^{k} {u}_{i} {σ}_{i} {v}_{i}^{T} , \\ {S}_{k} = diag ( {σ}_{1} , {σ}_{2} , ⋯ , {σ}_{k} , 0 , ⋯ 0 ) ∈ {R}^{n \times m} \qquad ( 10 )$$

In equation (10), the smallest (r−k) nonsingular value in the matrix S are replaced with zero, i.e., are truncated, wherein k≤r; r represents rank of the coefficient matrix B, k represents the amount of singular values retained in the matrix S; uᵢ represents the vector corresponding to matrix U, vᵢ represents the vector corresponding to matrix V, σᵢ represents the singular value retained in the matrix S. calculating the mean value of singular values in the matrix S and taking this mean value as the threshold value of the truncated singular values, wherein, in the matrix S, values greater than the threshold value are retained and values less than the threshold value are processed zero out; the truncated singular value solution \hat{X}_{TSVD}^{(k)} in equation (7) is:

$${\hat{X}}_{TSVD}^{( k )} ≡ {A}_{k}^{+} L = {\sum }_{i = 1}^{k} \frac{〈 {u}_{1} , L 〉}{{σ}_{i}} {v}_{i} \qquad ( 11 )$$

where Aₖ⁺=VSₖ⁺U^{T}, Sₖ⁺=diag(σ₁⁻¹, σ₂⁻¹, . . . , σₖ⁻¹, 0, . . . 0)∈R^{n×m};

According to the least squares principle V^{T}PV=min, equation (8) is written as follow:

(B^{T}PB)X=(B^{T}PL) (12)

The left and right of the equation of equation (12) are both added with the unknown parameter KX, which is simplified to obtain equation (13);

(B^{T}PB+KI)X=B^{T}PL+KX (13)

Equation (13) is sorted up into the corrected iteration equation of the least squares spectrum is:

X=(B^{T}PB+KI)⁻¹(B^{T}PL+KX) (14)

In equation (14), K is any real number. The spectrum corrected iteration equation of the least-squares is an iteration calculation method based on the least square; the solution to the unknown parameter X is calculated based on the spectrum corrected iteration equation of the least-squares. The calculation process is as follows:

The calculation of X based on the corrected iteration of the least squares spectrum includes two iteration processes of iteration \textcircled{1} and iteration \textcircled{2}; wherein, a first comparison threshold value is set to determine whether iteration \textcircled{1} is converged or not and a second comparison threshold value is set to determine whether iteration \textcircled{2} is converged or not.

Iteration \textcircled{1}: in the first iteration, the initial value of K is set as 1, the truncated singular value solution \hat{X}_{TSVD}^{(k)} obtained from equation (11) is taken as the initial value of X of equation (14) in the first iteration, which is assigned to X in the right of equation (14);

In each iteration process, the value of the unknown parameter X obtained in the last iteration from the equation (14) is taken as the initial value of X in the present iteration process, which is assigned to Xin the right of equation in equation (14);

The value of the unknown parameter X in each iteration process is calculated based on equation (14);

Calculating the difference value between the value of X obtained in each iteration process and the initial value of Xin each iteration;

If the different value obtained from the difference calculation is greater than the first comparison threshold value, it means that the iteration is not converged, which means the value of K in the corrected iteration of the least squares spectrum needs to be corrected by increasing the value of K by 1, then the above iteration \textcircled{1} process is continued;

If the difference value obtained from the difference calculation is less than equal to the first comparison threshold value, then end the iteration 0 and go to the iteration \textcircled{2}.

Iteration \textcircled{2}: comparing the value of the unknown parameter X obtained from equation (14) with the second comparison threshold value;

If the value of the unknown parameter X obtained from equation (14) is greater than the second comparison threshold value, it means the iteration \textcircled{2} is not converged, at this time, the location parameters (dX, dY, dZ) are respectively added into the approximate coordinate (X₀, Y₀, Z₀) to update the approximate coordinate of the station, by linearizing the standard point positioning error equation with updated approximates coordinate of the station through equation (5) and simplifying the linearized standard point positioning error equation through equation (6), go back to iteration 0 to calculate the value of the unknown parameter X.

If the value of the unknown parameter X obtained from equation (14) is less than or equal to the second comparison threshold value, it means the iteration \textcircled{2} is converged, then the iteration is ended; at this time, the value of the unknown parameter X obtained from equation (14) is the solution to the unknown parameter X.

After the unknown parameter X is calculated, go to the step I.3.5.

I.3.4. the solution to the unknown parameter X is calculated by the least square method, go to step I.3.5.

In the step I.3.4, the process of calculating the unknown parameter X based on the least square method is as follows:

a third comparison threshold value is set to determine whether the iteration is converged or not; in each iteration process, the value of the unknown parameter X by using equation (8), the value of the unknown parameter X obtained in the present iteration is compared with the third comparison threshold value;

if the value of the unknown parameter X obtained from equation (8) is greater than the third comparison threshold value, it means the iteration is not converged, at this time, the location parameters (dX, dY, dZ) are respectively added into the approximate coordinate (X₀, Y₀, Z₀) to update the approximate coordinate of the station, calculation processes of equation (5)-equation (8) are executed to calculate the value of the unknown parameter X again;

if the value of the unknown parameter X obtained from equation (8) is less than or equal to the third comparison threshold value, it means the iteration is converged, then the iteration is ended; at this time, the value of the unknown parameter X obtained from equation (8) is the solution to the undetermined and unknown parameter X.

I.3.5. parameter values contained in the unknown parameter X are obtained based on the solution to unknown parameter X, i.e. position parameters (dX, dY, dZ) of the station, receiver clock bias dtᵣ and the coefficient Cₙₘ and Sₙₘ of the spherical harmonics;

wherein, the position parameters (dX, dY, dZ) in the unknown parameter X are respectively introduced to the approximate coordinate (X₀, Y₀, Z₀) of the station, namely coordinate (X,Y,Z) of the station in the earth-centered earth-fixed coordinate system that are obtained from the standard point positioning.

The calculated coefficient Cₙₘ and Sₙₘ of the spherical harmonics can be directly used in the subsequent standard point positioning.

The specific application process is: reading the existing spherical harmonics coefficient and representing error terms mainly including the tropospheric delay error and the ionospheric delay error and related to the elevation angle and the azimuth angle between the station and the satellite through the spherical harmonics; when constructing the observation equation for the single point positioning, the correction for error terms related to the elevation angle and the azimuth angle between the station and the satellite is no longer taken into consideration and the calculation process for the tropospheric delay error and the ionospheric delay error in the positioning is ignored, which enables the positioning equation to merely calculate the position parameter of the station and the parameter for the receiver clock bias and the procedure of the standard point positioning is greatly simplified.

I.3.6. the coordinate of the station are transformed from the earth-centered earth-fixed coordinate system into the local Cartesian coordinate coordinate system to achieve GNSS standard point positioning.

The process of transforming the coordinate of the station form the earth-centered earth-fixed coordinate system into the local Cartesian coordinate coordinate system is as follows:

The equation of transforming the earth-centered earth-fixed coordinate system into the longitude and latitude and height coordinate system is:

$$\{ \begin{matrix}lon = arc tan ( \frac{Y}{X} ) \\ alt = \frac{p}{cos ( lat ) - M} \\ lat = arc tan [ \frac{Z}{p} {( 1 - {E}^{2} \frac{M}{M + alt} )}^{- 1} ] \\ p = \sqrt{{X}^{2} + {Y}^{2}}\end{matrix} \qquad ( 15 )$$

wherein, (X,Y,Z) are the coordinate of the earth-centered earth-fixed coordinate system, (lon, lat, alt) are the coordinate of the longitude and latitude and height coordinate system; M represents the radius of curvature for the reference ellipsoid, E represents the eccentricity ratio of the ellipsoid; according to the approximate coordinate (X₀, Y₀, Z₀) for the station, the coordinate corresponding to the approximate coordinate (X₀, Y₀, Z₀) of this station in the longitude and latitude and height coordinate system, i.e. (lon₀, lat₀, alt₀), are calculated by equation (15).

The equation of transforming the earth-centered earth-fixed coordinate system into the local Cartesian coordinate coordinate system is:

$$[ \begin{matrix}Δ x \\ Δ y \\ Δ z\end{matrix} ] = [ \begin{matrix}X \\ Y \\ Z\end{matrix} ] - [ \begin{matrix}{X}_{0} \\ {Y}_{0} \\ {Z}_{0}\end{matrix} ] , [ \begin{matrix}{e}_{1} \\ {n}_{1} \\ {u}_{1}\end{matrix} ] = S \times [ \begin{matrix}Δ x \\ Δ y \\ Δ z\end{matrix} ] \qquad ( 16 )$$

where (e₁, n₁, u₁) is the position of (X,Y,Z) coordinate calculated by taking the approximate coordinate (X₀, Y₀, Z₀) of the station as the original point.

S is the coordinate-transformation matrix,

$$S = [ \begin{matrix}- sin ( {lon}_{0} ) & cos ( {lon}_{0} ) & 0 \\ - sin ( {lat}_{0} ) cos ( {lon}_{0} ) & - sin ( {lat}_{0} ) sin ( {lon}_{0} ) & cos ( {lat}_{0} ) \\ cos ( {lat}_{0} ) cos ( {lon}_{0} ) & cos ( {lat}_{0} ) sin ( {lon}_{0} ) & sin ( {lat}_{0} )\end{matrix} ] ;$$

Based on the above coordinate transformation relationship, coordinate of the station are transformed from the earth-centered earth-fixed coordinate system into the local Cartesian coordinate coordinate system.

The GNSS standard point positioning method in the present embodiment 1 performs the standard point positioning fast, effectively and accurately based on error terms related to the elevation angle and the azimuth angle between the station and the satellite and represented by the spherical harmonics.

### Embodiment 2

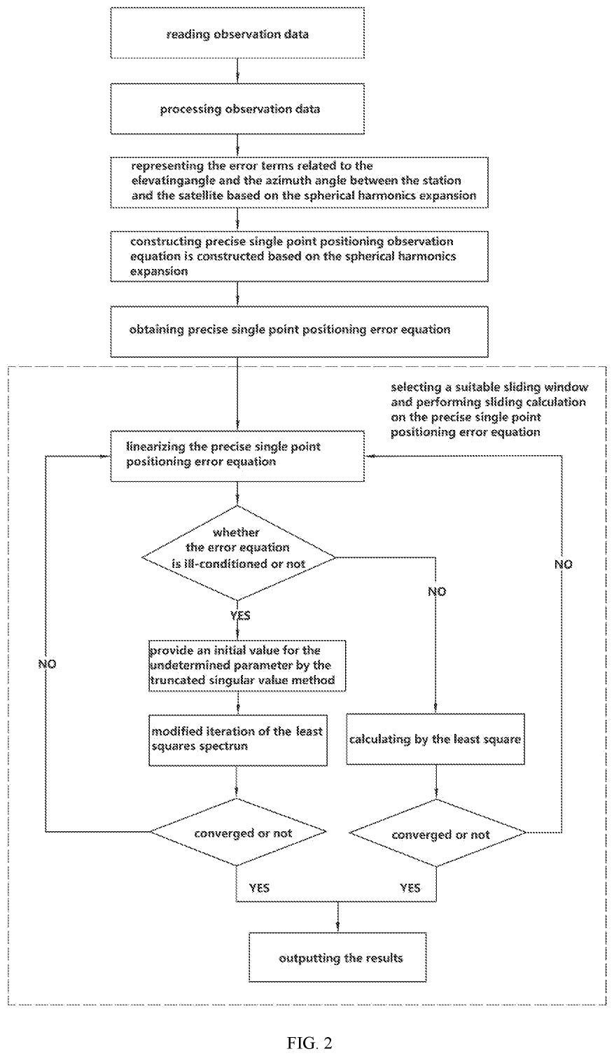

The present embodiment 2 describes a GNSS precise single point positioning method based on the spherical harmonics. As shown in FIG. 2, the GNSS precise single point positioning method based on the spherical harmonics includes the following steps:

II.1. establishing a precise single point positioning observation equation with a carrier phase observation value.

Reading the observation data, the broadcast ephemeris and the precise broadcast ephemeris, pre-processing the carrier phase observation data and calculating errors and not related to or not closely related to the elevation angle and the azimuth angle between the station and satellite, wherein the above error mainly includes initial values for calculating the satellite clock bias, the cycle slip detection and calculating the integer ambiguity estimate parameter of the carrier phase etc.

As the precision of the broadcast ephemeris rarely meets the requirement of the precision single point positioning, it needs the satellite precise ephemeris to calculate the satellite position; the satellite clock bias estimated by a second-order polynomial cannot meet the requirement for the precision of the precise single point positioning; as different satellite clock bias are all different, they must be ascertained firstly and then added into the observation equation to eliminate the influence.

At present, IGS provides a posterior precision ephemeris with a sample interval of 15 min and 5 min and a satellite clock bias product with a sample interval of 5 min and 30 s, which can meet the accuracy requirements of precision positioning. The sample interval of the observation value is generally less than the sample interval of data in the above file, so it is necessary to obtain the satellite position and satellite clock bias corresponding to each ephemeris by interpolation calculation.

A ground receiver clock always adopts a quartz clock and has a precision lower than the satellite clock. As changes to the clock bias are irregular and cannot be well fitted by a polynomial, the clock bias tᵣ of the receiver is estimated as an parameter.

the established observation equation for the precise single point positioning performed by using the carrier phase observation value is shown as equation (1).

φᵢ^{j}=Rᵢ^{j}+c·[(tᵣ)ᵢ−(tₛ)ᵢ^{j}]+(ρₜᵣₒₚ)ᵢ^{j}+(ρᵢₒₙ)ᵢ^{j}+λNᵢ^{j}+ε_{φ} (1)

in equation (1), i represents the number of i; j represents a satellite number; φ represents carrier phase observation value, wherein the carrier phase observation data shown as a distance obtained through multiplying the carrier phase original observation value by the corresponding wavelength λ is called the equivalent range; φᵢ^{j} represents the carrier phase observation value of a satellite j at epoch i, i.e., the equivalent range; Rᵢ^{j} represents the euclidean distance between the location of a receiver and the location of the satellite j at epoch i; tᵣ represents a clock bias of a receiver, (tᵣ)ᵢ represents the clock bias of a receiver at epoch i; tₛ represents a satellite clock bias, (tₛ)ᵢ^{j} represents the clock bias of the satellite j at epoch i; (ρₜᵣₒₚ)ᵢ^{j} represents the tropospheric delay error of a signal transmission path for the satellite j at epoch i; (ρᵢₒₙ)ᵢ^{j} represents the ionospheric delay error of a signal transmission path for the satellite j at epoch i; c represents the velocity of light; λ represents the wavelength of the carrier phase; N represents the integer ambiguity estimate parameter of the satellite phase observation data; Nᵢ^{j} represents the integer ambiguity estimate parameter for the phase observation data of the satellite j at epoch i; ε_{φ} represents a residual of the carrier phase. The three-dimensional coordinate at the moment of observing the satellite j at epoch i is defined as (Xᵢ^{j}, Yᵢ^{j}, Zᵢ^{j}), the approximate coordinate of the station is (X₀, Y₀, Z₀), then the euclidean distance (Rᵢ^{j})₀ between the satellite and the approximate location of the station is represented as:

(Rᵢ^{j})₀=\sqrt{(X₀−Xᵢ^{j})²+(Y₀−Yᵢ^{j})²+(Z₀−Zᵢ^{j})²}.

Types of the GNSS carrier phase observation data include the single frequency observation data and the dual-frequency observation data. If the GNSS receiver performing the standard point positioning is a dual-frequency receiver, then the ionospheric delay error is eliminated through the combination of the dual-frequency ionosphere and the specific combination method is as follows:

$$φ = \frac{{f}_{1}^{2}}{{f}_{1}^{2} - {f}_{2}^{2}} {φ}_{1} - \frac{{f}_{2}^{2}}{{f}_{1}^{2} - {f}_{2}^{2}} {φ}_{2} ;$$

wherein, φ is the observation value (equivalent range) of the pseudo-range ionosphere combination of the carrier phase; f₁, f₂ represent frequencies corresponding to the observation value; φ₁, φ₂ respectively represent the carrier phase observation values (equivalent range) corresponding to two frequencies. When the observation data is a dual-frequency observation value, in the above equation (1), the first-order principal term of the ionospheric delay error is eliminated through the combination of the dual-frequency ionosphere, the term (ρᵢₒₙ)ᵢ^{j} of the ionospheric delay error is 0.

At this time, in the observation equation for the precise single point positioning in the present Embodiment 2, the spherical harmonics has an order that is different from the observation equation established by the single frequency carrier phase observation value.

In the precise single point positioning, the calculation of the integer ambiguity and detection of the cycle slip is performed by GF (geometry independent) combination observation values consisting of carrier phase observation values. The specific combination method is as follows:

$$φ = {λ}_{1} {φ}_{1} - {λ}_{2} {φ}_{2} = ( \frac{1}{{f}_{2}^{2}} - \frac{1}{{f}_{1}^{2}} ) + ( {λ}_{1} {N}_{2} - {λ}_{2} {N}_{1} )$$

where φ represents GF observation combination values (equivalent range) consisting of carrier phase observation values; φ₁, φ₂ respectively represent the carrier phase observation values corresponding to two frequencies; λ₁, λ₂ respectively represent the wavelengths of the carrier phases corresponding to two frequencies; f₁, f₂ represent the frequencies of the two carrier phases. GF observation combination values are geometry independent, which means this combination is suitable to detect the cycle slip.

II.2. error terms including the tropospheric delay error and the ionospheric delay error and related to the elevation angle and the azimuth angle between the station and the satellite are represented based on the spherical harmonic expansion. In the precise single point positioning, the tropospheric delay error and the ionospheric delay error are all a single delay error produced when the satellite single passes through the atmosphere and all related to the satellite signal propagation; as the propagation path of the satellite single is related to the positions of the station and the satellite, the elevation angle and the azimuth angle between the station and satellite can be calculated by the station coordinate and the satellite position, error terms mainly including the tropospheric delay error and the ionospheric delay error and related to the elevation angle and the azimuth angle between the station and the satellite can be represented by the spherical harmonics to eliminate or weaken at a maximum order their influence on the results of the precise single point positioning. The observation equation represents for the precise single point positioning after the spherical harmonics:

$${φ}_{i}^{j} = {( {R}_{i}^{j} )}_{0} + c \cdot [ {( {t}_{r} )}_{i} - {( {t}_{s} )}_{i}^{j} ] + {\sum }_{n = 0}^{Nmax} {\sum }_{m = 0}^{n} {P}_{n m} ( cos ( {e}_{i}^{j} ) ) [ {C}_{n m} cos ( m ( {α}_{i}^{j} ) ) + {S}_{n m} sin ( m ( {α}_{i}^{j} ) ) ] + λ {N}_{i}^{j} + {ε}_{φ} \qquad ( 2 )$$

where n is the degree of the spherical harmonics, m is the order of the spherical harmonics, Nmax is the maximum order of the spherical harmonics; Pₙₘ(cos(eᵢ^{j})) represents the Associated Legendre polynomials in degree n and order m; Cₙₘ and Sₙₘ represent coefficients of the spherical harmonics in degree n and order m; eᵢ^{j} represents the elevation angle between the station and the satellite j at epoch i and αᵢ^{j} represents the azimuth angle between the station and the satellite j at epoch i. The observation equation for the precise single point positioning based on the spherical harmonics proposed by equation (2) does not relate to the correction model of the tropospheric delay error, which means there is no need to take the application issues of different models in different areas. Moreover, the coefficient of the spherical harmonics is calculated as the parameter in the present embodiment to correct error terms mainly including the tropospheric delay error and related to the elevation angle and the azimuth angle between the station and the satellite, which means there is no need to consider the meteorological information and it presents more universality; for the convenience of representing the spherical harmonics, take:

$${T}_{i}^{j} = {\sum }_{n = 0}^{Nmax} {\sum }_{m = 0}^{n} {P}_{n m} ( cos ( {e}_{i}^{j} ) ) [ {C}_{n m} cos ( m ( {α}_{i}^{j} ) ) + {S}_{n m} sin ( m ( {α}_{i}^{j} ) ) ] ;$$

Then equation (2) is simplified as: φᵢ^{j}=(Rᵢ^{j})₀+c·[(tᵣ)ᵢ−(tₛ)ᵢ^{j}]+λNᵢ^{j}+Tᵢ^{j}+ε_{φ}(3)

The error equation for the precise single point positioning is obtained from the precise single point positioning in equation (3):

(v_{φ})ᵢ^{j}=(Rᵢ^{j})+c·[(tᵣ)ᵢ−(tₛ)ᵢ^{j}]+λNᵢ^{j}+Tᵢ^{j}−φᵢ^{j} (4)

where v_{φ} represents the correction value of the carrier phase observation data (equivalent range);

(v_{φ})ᵢ^{j} represents the correction value of the carrier phase observation data (equivalent range) of satellite j at epoch i.

II.3. the simplification process is performed based on the linearization expression obtained from the precise single point positioning error equation (4), then the sliding calculation is performed on the linearization expression of the precise single point positioning error equation.

II.3.1. the Taylor series expansion is performed on the approximate coordinate (X₀, Y₀, Z₀) of the precise single point positioning error equation (4) in the station and the first-order item is retained, then the linearization expression obtained from the precise single point positioning error equation is:

$${( {v}_{φ} )}_{i}^{j} = {( {R}_{i}^{j} )}_{0} + \frac{{X}_{0} - {X}_{i}^{j}}{{( {R}_{i}^{j} )}_{0}} dX + \frac{{Y}_{{0}^{-}} {Y}_{i}^{j}}{{( {R}_{i}^{j} )}_{0}} dY + \frac{{Z}_{0} - {Z}_{i}^{j}}{{( {R}_{i}^{j} )}_{0}} dZ + \frac{\partial {T}_{i}^{j}}{\partial {C}_{n m}} {dC}_{n m} + \frac{\partial {T}_{i}^{j}}{\partial {S}_{n m}} d {S}_{n m} = {d ( {t}_{r} )}_{i} + {dN}_{i}^{j} - c \cdot {( {t}_{s} )}_{i}^{j} + {( λ {N}_{i}^{j} )}_{0} - {φ}_{i}^{j} \qquad ( 5 )$$

in equation (5), (λNᵢ^{j})₀ represents the initial ambiguity value of satellite j at epoch i; Nᵢ^{j} represents the integer ambiguity parameter of the phase observation data in satellite j at epoch i; dN represent the correction number of the integer ambiguity parameter of the phase observation data; dNᵢ^{j} represent the correction number of the integer ambiguity parameter of the phase observation data in satellite j at epoch i. As the integer ambiguity parameter cannot be well modeled in the precise single point positioning, the correction number is calculated as an parameter. When calculated as an parameter, dNᵢ^{j} has a coefficient of 1; d(t) represents the parameter of the clock bias for the station receiver in satellite j at epoch i. As the clock bias for the station receiver cannot be fitted by a polynomial, as is similar to the process method of the integer ambiguity, it is calculated as an parameter. When calculated as an parameter, dtᵣ has a coefficient of 1.

$$\frac{{X}_{0} - {X}_{i}^{j}}{{( {R}_{i}^{j} )}_{0}} = {I}_{i}^{j} , \frac{{Y}_{0} - {Y}_{i}^{j}}{{( {R}_{i}^{j} )}_{0}} = {J}_{i}^{j} , \frac{{Z}_{0} - {Z}_{i}^{j}}{{( {R}_{i}^{j} )}_{0}} = {K}_{i}^{j} ;$$

$$\frac{\partial {T}_{i}^{j}}{\partial {C}_{n m}} = {P}_{n m} ( cos ( {e}_{i}^{j} ) ) cos ( m ( {α}_{i}^{j} ) ) ,$$

$$\frac{\partial {T}_{i}^{j}}{\partial {S}_{n m}} = {P}_{n m} ( cos ( {e}_{i}^{j} ) ) sin ( m ( {α}_{i}^{j} ) ) ;$$

$${P}_{n m} ( cos ( {e}_{i}^{j} ) ) cos ( m ( {α}_{i}^{j} ) ) = {( {A}_{n m} )}_{i}^{j} ,$$

$${P}_{n m} ( cos ( {e}_{i}^{j} ) ) sin ( m ( {α}_{i}^{j} ) ) = {( {B}_{n m} )}_{i}^{j} .$$

If is the coefficient of the parameter dX calculated from the approximate coordinate of the station and coordinate of the satellite j at epoch i, the parameter dX is the correct value of the approximate coordinate X₀ of the station; Jᵢ^{j} represents the coefficient of the parameter dY calculated from the approximate coordinate of the station and coordinate of the satellite j at epoch i, the parameter dY is the correct value of the approximate coordinate Y₀ of the station; Kᵢ^{j} is the coefficient of the parameter dZ calculated from the approximate coordinate of the station and coordinate of the satellite j at epoch i, the parameter dZ is the correct value of the approximate coordinate Z₀ of the station; Aₙₘ represents the coefficient of the parameter Cₙₘ based on spherical harmonics, Bₙₘ represents the coefficient of the parameter Sₙₘ based on spherical harmonics; (Aₙₘ)ᵢ^{j} is the coefficient of the parameter Cₙₘ of the spherical harmonics calculated from the approximate coordinate of the station and coordinate of the satellite j at epoch i; (Bₙₘ) is the coefficient of the parameter Sₙₘ of the spherical harmonics calculated from the approximate coordinate of the station and coordinate of the satellite j at epoch i.

The simplified linearization expression for the precise single point positioning error equation is shown as equation (6);

(v_{φ})ᵢ^{j}=Iᵢ^{j}dX+Jᵢ^{j}dY+Kᵢ^{j}dZ+d(tᵣ)ᵢ+dNᵢ^{j}+(Aₙₘ)ᵢ^{j}dCₙₘ+(Bₙₘ)ᵢ^{j}dSₙₘ−(w_{φ})ᵢ^{j} (6)

in equation (6), i=1, 2, . . . , epoch, epoch represents the maximum epoch of observation;

(w_{φ})ᵢ^{j} represents the constant term calculated from the carrier phase observation value of the satellite j at epoch i, the clock bias of the satellite j at epoch i, the integer ambiguity initial value for the phase observation data at the satellite j at epoch i and the euclidean distance between the approximate coordinate of the station and the satellite j at epoch i, wherein, (w_{φ})ᵢ^{j}=φᵢ^{j}−(Rᵢ^{j})₀+c·(tₛ)ᵢ^{j}−(λNᵢ^{j})₀. It can be seen from equation (6) that there are observation equations in an amount of epoch×j at this time. But the parameter includes 3 position parameters (dX, dY, dZ), the receiver clock bias dtᵣ parameters in an amount of epoch, ambiguity parameter dN in amount of j and parameters Cₙₘ and Sₙₘ of the spherical harmonics in an amount of (Nmax+1)².

When the epoch is large enough, the optimum solutions for all unknown numbers can be obtained from the least squares. As long as the correction terms can be described, the amount of the observation equation can be increased through the manner of increasing the observation epoch to calculate the unknown parameters.

The sliding window is configured to select epochs in an amount of i and each epoch can observe up to satellites in an amount of j, the carrier phase observation values of all satellites under this sliding window consist of equations in an amount of imax, wherein, imax=i×j.

When the coefficient matrix of the precise single point positioning error equation, the vector matrix of correction number for the carrier phase observation value, the constant term matrix and the parameter matrix to be estimated are respectively defined as B, V, L, X, then their expressions are respectively shown as:

$$B = [ \begin{matrix}{I}_{1}^{1} & {J}_{1}^{1} & {K}_{1}^{1} & 1 & 0 & ⋯ & 0 & 1 & 0 & ⋯ & 0 & {( {A}_{00} )}_{1}^{1} & {( {A}_{10} )}_{1}^{1} & ⋯ & {( {B}_{NmaxNmax} )}_{1}^{1} \\ {I}_{1}^{2} & {J}_{1}^{2} & {K}_{1}^{2} & 1 & 0 & ⋮ & 0 & 0 & 1 & ⋯ & 0 & {( {A}_{00} )}_{1}^{2} & {( {A}_{10} )}_{1}^{2} & ⋯ & {( {B}_{NmaxNmax} )}_{1}^{2} \\ ⋮ & ⋮ & ⋮ & ⋮ & ⋮ & ⋱ & ⋮ & ⋮ & ⋮ & ⋱ & ⋮ & ⋮ & ⋮ & ⋱ & ⋮ \\ {I}_{2}^{1} & {J}_{2}^{1} & {K}_{2}^{1} & 0 & 1 & ⋯ & 0 & 0 & 0 & 0 & 0 & {( {A}_{00} )}_{2}^{1} & {( {A}_{10} )}_{2}^{1} & & {( {B}_{NmaxNmax} )}_{2}^{1} \\ ⋮ & ⋮ & ⋮ & ⋮ & ⋮ & ⋱ & ⋮ & ⋮ & ⋮ & ⋱ & ⋮ & ⋮ & ⋮ & ⋱ & ⋮ \\ {I}_{imax}^{j} & {J}_{imax}^{j} & {K}_{imax}^{j} & 0 & 0 & … & 1 & 0 & 0 & 0 & 1 & {( {A}_{00} )}_{imax}^{j} & {( {A}_{10} )}_{imax}^{j} & … & {( {B}_{NmaxNmax} )}_{imax}^{j}\end{matrix} ]$$

$$V = {[ \begin{matrix}{( {v}_{φ} )}_{1}^{1} & {( {v}_{φ} )}_{1}^{2} & ⋯ & {( {v}_{φ} )}_{2}^{1} & ⋯ & {( {v}_{φ} )}_{imax}^{j}\end{matrix} ]}^{T} ;$$

$$L = {[ \begin{matrix}- {( {w}_{φ} )}_{1}^{1} & - {( {w}_{φ} )}_{1}^{2} & ⋯ & - {( {w}_{φ} )}_{2}^{1} & ⋯ & - {( {w}_{φ} )}_{imax}^{j}\end{matrix} ]}^{T} ;$$

$$X = [ \begin{matrix}dX & dY & dZ & {( {dt}_{r} )}_{1} & ⋯ & {( {dt}_{r} )}_{i} & {( dN )}_{1}^{1} & ⋯ & {( dN )}_{imax}^{j} & {C}_{00} & ⋯ & {C}_{NmaxNmax} & {{S}_{NmaxNmax} ]}^{T}\end{matrix}$$

(dN)₁¹ represents the integer ambiguity parameter of 1^{st} satellite at 1^{st} epoch of observation, (dN)ᵢₘₐₓ^{j} represents the integer ambiguity parameter of the satellite j at epoch i. What is calculated from the precise single point positioning is the correction number of the integer ambiguity parameter.

The linearization expression of the precise single point positioning error equation (6) is expressed by one matrix form, as shown by equation (7);

V=BX−L (7)

When constructing the coefficient matrix B in precise single point positioning error equation (7), it only needs to calculate the coefficients for each parameter (position parameter, station receiver clock bias parameter, the integer ambiguity parameter and parameters of the spherical harmonics) through simple mathematic calculation, wherein the calculation process is simple, the construction of the error equation is fast and the achievement of the precise single point positioning is effective. At present, as error terms including the tropospheric delay error and related to the elevation angle and the azimuth angle between the station and the satellite cannot be corrected by a model precisely, it is an excellent way to solve it as the parameter in reference to receiver clock bias parameters for the station. The GNSS precise single point positioning method based on the spherical harmonics is proposed on this idea and the coefficient of spherical harmonics is directly calculated in the precise single point positioning equation by representing error terms related to the elevation angle and the azimuth angle between the station and the satellite with the spherical harmonics. The least square of the unknown parameter X is estimated as: X=(B^{T}PB)⁻¹ B^{T}PL(8)

in equation (8), P is the unit weighting matrix.

II.3.2. if the coefficient matrix B of the precise single point positioning error equation is well-conditioned, the solution to the unknown parameter calculated from equation (8) is the optimum unbiased estimation. When the coefficient matrix B is ill-conditioned, what is calculated from the least square is no longer the optimum solution.

Therefore, firstly a judgment is performed to determine where the coefficient matrix B in the precise single point positioning error equation is ill-conditioned or not, if the judgment determines that the coefficient matrix B is ill-conditioned, then step II.3.3 is executed; otherwise, if the coefficient matrix B is determined as well-conditioned, the step II.3.4 is executed

The present embodiment calculates the conditional number of the coefficient matrix B in the precise single point positioning error equation, sets the empirical threshold value for the conditional number and compares the conditional number with the empirical threshold value, when the conditional number is greater than the empirical threshold value, the error equation is ill-conditioned.

II.3.3. in order to solve the ill-conditioned problem of the error equation, the present embodiment proposes a method using the truncated singular value decomposition to provide an initial value for the parameter X for the spectrum corrected iteration equation of the least-squares and calculates the value of the parameter based on the spectrum corrected iteration equation of the least-squares. As the truncated singular value decomposition method transforms the least square method of the equation into the direct solution, an excessive deviation of the solution to the ill-conditioned equation from the real solution is avoided, which effectively solves the ill-conditioned problem for the coefficient matrix B in the error equation.

It is assumed that the coefficient matrix B∈R^{n×m}, R^{n×m} represents the real matrix of n rows and m columns; then the singular value decomposition of the coefficient matrix B is:

B=USV^{T} (9)

in equation (9), U∈n×n, V∈m×m, U and V are all orthogonal matrixes, S∈n×m is a diagonal matrix;

The truncated singular value matrix Bₖ of the coefficient matrix B∈R^{n×m} is defined as:

$${B}_{k} ≡ {US}_{k} {V}^{T} = {\sum }_{i = 1}^{k} {u}_{i} {σ}_{i} {v}_{i}^{T} , {S}_{k} = diag ( {σ}_{1} , {σ}_{2} , ⋯ , {σ}_{k} , 0 , ⋯ 0 ) ∈ {R}^{n \times m} \qquad ( 10 )$$

in equation (10), the smallest (r−k) nonsingular value in the matrix S are replaced with zero, i.e., are truncated, wherein k≤r; r represents rank of the coefficient matrix B, k represents the amount of singular values retained in the matrix S; uᵢ represents the vector corresponding to matrix U, vᵢ represents the vector corresponding to matrix V, σᵢ represents the singular value retained in the matrix S; calculating the mean value of singular values in the matrix S and taking this mean value as the threshold value of the truncated singular values, wherein, in the matrix S, values greater than the threshold value of the truncated singular values are retained and values less than the threshold value of the truncated singular values are processed zero out; the truncated singular value solution \hat{X}_{TSVD}^{(k)} in equation (7) is:

$${\hat{X}}_{TSVD}^{( k )} ≡ {A}_{k}^{+} L = {\sum }_{i = 1}^{k} \frac{〈 {u}_{1} , L 〉}{{σ}_{i}} {v}_{i} \qquad ( 11 )$$

where Aₖ⁺=VSₖ⁺U^{T}, Sₖ⁺=diag(σ₁⁻¹, σ₂⁻¹, . . . , 0, . . . 0)∈R^{n×m};

The corrected iteration of the least squares spectrum is an iteration calculation method based on the least squares. Based on the parameter X for the corrected iteration of the least squares spectrum and according to the least squares principle V^{T}PV=min, equation (8) is written as follow:

(B^{T}PB)X=(B^{T}PL) (12)

The left and right of the equation of equation (12) are both added with the unknown parameter KX, which is simplified to obtain equation (13);

(B^{T}PB+KI)X=B^{T}PL+KX (13)

Equation (13) is sorted up into the corrected iteration equation of the least squares spectrum is:

X=(B^{T}PB+KI)⁻¹(B^{T}PL+KX) (14)

in equation (14), K is any real number; the solution to the unknown parameter X is calculated based on the spectrum corrected iteration equation of the least-squares.

The process of calculating the parameter X for the corrected iteration of the least squares spectrum is as follows:

The calculation of X based on the corrected iteration of the least squares spectrum includes two iteration processes of iteration \textcircled{1} and iteration \textcircled{2}; wherein, a first comparison threshold value is set to determine whether iteration \textcircled{1} is converged or not and a second comparison threshold value is set to determine whether iteration \textcircled{2} is converged or not;

Iteration \textcircled{1}: in the first iteration, the initial value of K is set as 1, the truncated singular value solution \hat{X}_{TSVD}^{(k)} obtained from equation (11) is taken as the initial value of X of equation (14) in the first iteration, which is assigned to X in the right of equation (14);

In each iteration process, the value of the unknown parameter X obtained in the last iteration from the equation (14) is taken as the initial value of X in the present iteration process, which is assigned to Xin the right of equation in equation (14);

The value of the unknown parameter X in each iteration process is calculated based equation (14);

Calculating the difference value between the value of X obtained in each iteration process and the initial value of Xin each iteration;

If the different value obtained from the difference calculation is greater than the first comparison threshold value, it means that the iteration is not converged, which means the value of K in the corrected iteration of the least squares spectrum needs to be corrected by increasing the value of K by 1, then the above iteration \textcircled{1} process is continued;

If the difference value obtained from the difference calculation is less than equal to the first comparison threshold value, then end the iteration \textcircled{1} and go to the iteration \textcircled{2};

Iteration \textcircled{2}: comparing the value of the unknown parameter X obtained from equation (14) with the second comparison threshold value;

If the value of the unknown parameter X obtained from equation (14) is greater than the second comparison threshold value, it means the iteration \textcircled{2} is not converged. At this time, the location parameters (dX, dY, dZ) are respectively added into the approximate coordinate (X₀, Y₀, Z₀) to update the approximate coordinate of the station, by linearizing the precise single point positioning error equation with updated approximates coordinate of the station through equation (5) and simplifying the linearized precise single point positioning error equation through equation (6), go back to iteration \textcircled{1} to calculate the value of the unknown parameter X;

If the value of the unknown parameter X obtained from equation (14) is less than or equal to the second comparison threshold value, it means the iteration @ is converged, then the iteration is ended; at this time, the value of the unknown parameter X obtained from equation (14) is the solution to the undetermined and unknown parameter X.

After the unknown parameter X is calculated, go to the step II.3.5.

II.3.4. the solution to the unknown parameter X is calculated by the least square method, go to step II.3.5.

In the step II.3.4, the process of calculating the unknown parameter X based on the least square method is as follows:

A third comparison threshold value is set to determine whether the iteration is converged or not; in each iteration process, the value of the unknown parameter X by using equation (8), the value of the unknown parameter X obtained in the present iteration is compared with the third comparison threshold value;

If the value of the unknown parameter X obtained from equation (8) is greater than the third comparison threshold value, it means the iteration is not converged, at this time, the location parameters (dX, dY, dZ) are respectively added into the approximate coordinate (X₀, Y₀, Z₀) to update the approximate coordinate of the station;

Calculation processes of equation (5)-equation (8) are executed to calculate the value of the unknown parameter X again;

If the value of the unknown parameter X obtained from equation (8) is less than or equal to the third comparison threshold value, it means the iteration is converged, then the iteration is ended; at this time, the value of the unknown parameter X obtained from equation (8) is the solution to the undetermined and undetermined and unknown parameter X.

II.3.5. parameter values contained in the unknown parameter X are obtained based on the solution to unknown parameter X, i.e. position parameters (dX, dY, dZ) of the station, receiver clock bias dtᵣ, ambiguity parameter dN and the coefficient Cₙₘ and Sₙₘ of the spherical harmonics;

wherein, position parameters (dX, dY, dZ) in are respectively introduced to the approximate coordinate (X₀, Y₀, Z₀) of the station, namely coordinate (X,Y,Z) of the station in the earth-centered earth-fixed coordinate system that are obtained from the precise single point positioning. The calculated coefficient Cₙₘ and Sₙₘ of the spherical harmonics can be directly used in the subsequent precise single point positioning, the specific application process is:

Reading the existing spherical harmonics coefficient and representing error terms including the tropospheric delay error and the ionospheric delay error and related to the elevation angle and the azimuth angle between the station and the satellite through the spherical harmonics; when constructing the observation equation for the precise single point positioning, the correction for error terms related to the elevation angle and the azimuth angle between the station and the satellite is no longer taken into consideration and the calculation process for the tropospheric delay error and the ionospheric delay error during the positioning is ignored, which enables the positioning equation to merely calculate the position parameter of the station, the parameter for the receiver clock bias and the integer ambiguity parameter and the procedure of the precise single point positioning is greatly simplified.

II.3.6. the coordinate of the station are transformed from the earth-centered earth-fixed coordinate system into the local Cartesian coordinate coordinate system to achieve GNSS precise single point positioning, wherein the coordinate transformation process in the present Embodiment 2 is the same with the coordinate transformation process in the present Embodiment 1, which will not be described again.

The GNSS precise single point positioning method in the present embodiment 2 performs the standard point positioning fast, effectively and accurately based on error terms related to the elevation angle and the azimuth angle between the station and the satellite and represented by the spherical harmonics.

The precision that can be reached by the GNSS standard point positioning method based on the spherical harmonics in the present invention is now described:

Taking the Sheshan station, Shanghai as an example:

The GNSS observation data and the satellite broadcast ephemeris from Sheshan station on Jan. 7, 2019 are obtained.

The sample interval of the GNSS observation data is 30 s, the observation data adopts the dual-frequency pseudo-range and the dual-frequency carrier phase observation value of GPS satellite and the reference coordinate of the observation site is the station coordinate provided by IGS.

1. Firstly the station position information is obtained by using the GNSS standard point positioning method based on the spherical harmonics.

When the observation data adopts the dual-frequency pseudo-range of the GPS satellite, then the ionospheric delay error is eliminated through the pseudo-range linear combination.

Error terms mainly including the tropospheric delay error and related to the elevation angle and the azimuth angle between the station and the satellite are represented by the spherical harmonics. The coefficient for each degree and order of the spherical harmonics and the receiver clock bias of the station need to be calculated as an parameter.

The spherical harmonics function is expanded to 3 orders and the sliding window adopts 10 epochs. The parameters include: correction values of positioning coordinate in 3 directions, 10 receiver clock bias (each epoch has a receiver clock bias parameter), 16 coefficients of 3 order and 3 order expanded by the spherical harmonics: A₀₀, A₁₀, A₁₁, B₁₁, A₂₀, A₂₁, B₂₁, A₂₂, B₂₂, A₃₀, A₃₁, B₃₁, A₃₂, B₃₂, A₃₃, B₃₃.

The elevation mask of the satellite is set as 5° and the coefficient k for the spectrum corrected iteration equation of the least-squares is set as 2.

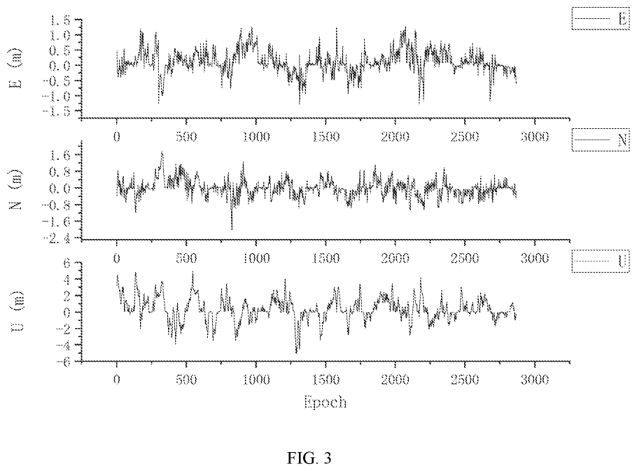

Positioning results for the GNSS standard point positioning method are shown in FIG. 3 and statistic results can refer to Table 1.

TABLE 1
standard point positioning precision (unit/m)

| | E | N | U |
|---|---|---|---|
| MAX | 1.2662 | 1.7738 | 4.9711 |
| MIN | −1.3027 | −2.0436 | −5.0853 |
| MEAN | 0.1101 | −0.0136 | 0.3269 |
| STD | 0.3727 | 0.3952 | 1.3887 |
| RMS | 0.3886 | 0.3954 | 1.4267 |

TABLE 2
Bernese positioning precision (unit/m)

| | E | N | U |
|---|---|---|---|
| MAX | 6.0917 | 5.7515 | 9.7484 |
| MIN | −3.8416 | −5.8132 | −11.1756 |
| MEAN | 0.1268 | −0.1259 | 0.5520 |
| STD | 1.2744 | 1.6002 | 3.0886 |
| RMS | 1.2807 | 1.6052 | 3.1375 |

It is not difficult to see form Table 1 that RMS of positioning results obtained from the standard point positioning method in the present invention in E direction is superior to 0.39 m, RMS thereof in N direction is superior to 0.40 m and RMS thereof in U direction is superior to 1.43 m.

Standard point positioning results calculated by the worldwide famous GNSS high precision data process Bernese software developed by Institute of Astronomy, University of Bern, Switzerland are shown in Table 2.

Accordingly, RMS of the standard point positioning results calculated by the GNSS high precision data process Bernese software in E direction is superior to 1.28 m, RMS thereof in N direction is superior to 1.61 m and RMS thereof in U direction is superior to 3.14 m.

It can be seen from the statistic table that standard point positioning results in the present invention have the same precision with the standard point positioning results obtained from the Bernese software.

2. The station position information is obtained by using GNSS standard point positioning method based on the spherical harmonics in the present invention.

When the observation data adopts the dual-frequency carrier phase observation value of the GPS satellite, then the ionospheric delay error is eliminated by the carrier phase linear combination. error terms mainly including the tropospheric delay error and related to the elevation angle and the azimuth angle between the station and the satellite are represented by the spherical harmonics. The coefficient for each order and order of the spherical harmonics and the receiver clock bias of the station need to be calculated as an parameter.

The integer ambiguity for each satellite carrier phase observation data and the receiver clock bias for the station also need to be calculated as an parameter. The spherical harmonics function is expanded to 6 orders and the sliding window adopts 15 epochs.

Parameters needs to be calculated include: correction values of positioning coordinate in 3 directions, 15 receiver clock bias (each epoch has a receiver clock bias parameter), the ambiguity parameter of each satellite under each epoch and 49 coefficients of 6 order and 6 order expanded by the spherical harmonics: A₀₀, A₁₀, A₁₁, B₁₁, A₂₀, A₂₁, B₂₁, A₂₂, B₂₂, A₃₀, A₃₁, B₃₁, A₃₂, B₃₂, A₃₃, B₃₃, A₄₀, A₄₁, B₄₁, A₄₂, B₄₂, A₄₃, B₄₃, A₄₄, B₄₄, A₅₀, A₅₁, B₅₁, A₅₂, B₅₂, A₅₃, B₅₃, A₅₄, B₅₄, A₅₅, B₅₅, A₆₀, A₆₁, B₆₁, A₆₂, B₆₂, A₆₃, B₆₃, A₆₄, B₆₄, A₆₅, B₆₅, A₆₆, B₆₆.

The elevation mask of the satellite is set as 5° and the coefficient k for the spectrum corrected iteration equation of the least-squares is set as 3.

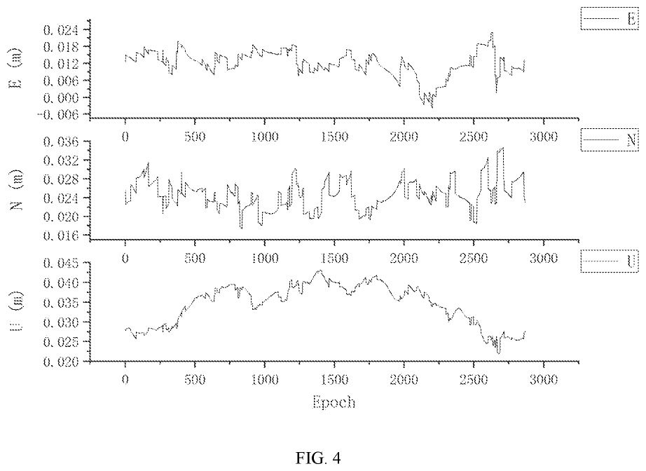

Positioning results for the GNSS standard point positioning method are shown in FIG. 4 and statistic results can refer to Table 3.

TABLE 3
precise single point positioning precision (unit/m)

| | E | N | U |
|---|---|---|---|
| MAX | 0.0230 | 0.0345 | 0.0432 |
| MIN | −0.0041 | 0.0173 | 0.0218 |
| MEAN | 0.0120 | 0.0246 | 0.0344 |
| STD | 0.0044 | 0.0031 | 0.0051 |
| RMS | 0.0128 | 0.0248 | 0.0348 |

TABLE 4
Bernese positioning precision (unit/m)

| | E | N | U |
|---|---|---|---|
| MAX | 0.0274 | 0.0301 | 0.0461 |
| MIN | −0.0178 | −0.0209 | −0.0738 |
| MEAN | 0.0036 | 0.0048 | −0.0082 |
| STD | 0.0075 | 0.0092 | 0.0200 |
| RMS | 0.0083 | 0.0104 | 0.0216 |

It is not difficult to see form Table 3 that RMS of positioning results obtained from the standard point positioning method in the present invention in E direction is superior to 0.02 m, RMS thereof in N direction is superior to 0.03 m and RMS thereof in U direction is superior to 0.04 m. standard point positioning results calculated by the worldwide famous GNSS high precision data process Bernese software developed by Institute of Astronomy, University of Bern, Switzerland are shown in Table 4.

Accordingly, RMS of the standard point positioning results calculated by the GNSS high precision data process Bernese software in E direction is superior to 0.009 m, RMS thereof in N direction is superior to 0.02 m and RMS thereof in U direction is superior to 0.03 m.

It can be seen from the statistic table that standard point positioning results in the present invention have the same precision with the standard point positioning results obtained from the Bernese software.

The GNSS standard point positioning method based on the spherical harmonics in the present invention obtains the positioning information fast and effectively by using the observation data and the satellite broadcast ephemeris and presents advantages such as effective calculation, no need to provide meteorological files, simple operation, reliable measurement results and high measurement precision compared with the method of correcting the tropospheric delay by using the empirical model.

1. A GNSS standard point positioning method based on spherical harmonics, including the following steps:
I.1. establishing an equation for standard point positioning observation as shown in equation (1) using pseudo-range by reading observations and broadcast ephemeris, processing pseudo-range observations, and calculating errors that are unrelated or not closely related to the elevation and azimuth angle between the station and the satellite:
ρᵢ^{j}=Rᵢ^{j}+c·[(tᵣ)ᵢ−(tₛ)ᵢ^{j}]+(ρₜᵣₒₚ)ᵢ^{j}+(ρᵢₒₙ)ᵢ^{j}+ε_{ρ} (1)
where i represents the number of epoch, j represents a satellite number; ρ represents a pseudo-range, ρᵢ^{j} represents the pseudo-range of a satellite j at epoch i; Rᵢ^{j} represents the euclidean distance between the location of a receiver and the location of the satellite j at epoch i of observation; c represents the velocity of light; tᵣ represents a clock bias of a receiver, (tᵣ)ᵢ represents the clock bias of a receiver at epoch i; tₛ represents a satellite clock bias, (tₛ)ᵢ^{j} represents the clock bias of the satellite j at epoch i; (ρₜᵣₒₚ)ᵢ^{j} represents the tropospheric delay error of a signal transmission path for the satellite j at epoch i; (ρᵢₒₙ)ᵢ^{j} represents the ionospheric delay error of a signal transmission path for the satellite j at epoch i; ε_{ρ} represents a pseudo-range observations residual;
a three-dimensional coordinate at the moment of observing the satellite j at epoch i is defined as (Xᵢ^{j}, Yᵢ^{j}, Zᵢ^{j}), an approximate coordinate of the station is (X₀, Y₀, Z₀), then the euclidean distance (Rᵢ^{j})₀ between the satellite and the approximate location of the station is represented as:
(Rᵢ^{j})₀=\sqrt{(X₀−Xᵢ^{j})²+(Y₀−Yᵢ^{j})²+(Z₀−Zᵢ^{j})²};
I.2. spherical harmonics are used to describe the errors related to the elevation and azimuth angle between the station and the satellite, including tropospheric delay errors and ionospheric delay errors produced when the satellite single passes through the atmosphere, where the elevation and azimuth angle between the station and the satellite are calculated by utilizing coordinate of the station and position of the satellite; the standard point positioning observation equation based on the spherical harmonics is represented as:
$${ρ}_{i}^{j} = {( {R}_{i}^{j} )}_{0} + c \cdot [ {( {t}_{r} )}_{i} - {( {t}_{s} )}_{i}^{j} ] + {\sum }_{n = 0}^{Nmax} {\sum }_{m = 0}^{n} {P}_{n m} ( cos ( {e}_{i}^{j} ) ) [ {C}_{n m} cos ( m ( {α}_{i}^{j} ) ) + {S}_{n m} sin ( m ( {α}_{i}^{j} ) ) ] + {ε}_{ρ} \qquad ( 2 )$$
where n is the degree of the spherical harmonics, m is the order of the spherical harmonics, Nmax is the maximum degree of the spherical harmonics; Pₙₘ(cos(eᵢ^{j})) represents the Associated Legendre polynomials in degree n and order m; Cₙₘ and Sₙₘ respectively represent coefficients of the spherical harmonics in degree n and order m, Cₙₘ and Sₙₘ are the parameter of the spherical harmonics; eᵢ^{j} and αᵢ^{j} respectively represent the elevation angle and the azimuth angle between the station and the satellite j at epoch i; for the convenience of representing the spherical harmonics, take:
$${T}_{i}^{j} = {\sum }_{n = 0}^{Nm ax} {\sum }_{m = 0}^{n} {P}_{n m} ( cos ( {e}_{i}^{j} ) ) [ {C}_{n m} cos ( m ( {α}_{i}^{j} ) ) + {S}_{n m} sin ( m ( {α}_{i}^{j} ) ) ] ;$$
then equation (2) is simplified as ρᵢ^{j}=(Rᵢ^{j})₀+c·[(tᵣ)ᵢ−(tₛ)ᵢ^{j}]+Tᵢ^{j}+ε_{ρ}(3)
the standard point positioning error equation (4) is obtained from the simplified standard point positioning observation equation (3) by the following equation:
(v_{ρ})ᵢ^{j}=(Rᵢ^{j})₀+c·[(tᵣ)ᵢ−(tₛ)ᵢ^{j}]+Tᵢ^{j}−ρᵢ^{j} (4)
where v_{ρ} represents the correction value of the pseudo-range observations;
(v_{ρ})ᵢ^{j} represents the correction value of the pseudo-range observations for the satellite j at epoch i;
I.3. the simplification process is performed based on the linearization expression obtained from the standard point positioning error equation (4), a sliding calculation is performed on the linearization expression of the standard point positioning error equation;
I.3.1. a Taylor series expansion is performed on an approximate coordinate (X₀, Y₀, Z₀) of the standard point positioning error equation (4) in the station and the first-order item is retained, then the linearization expression obtained from the standard point positioning error equation is shown as equation (5);
$${( {v}_{ρ} )}_{i}^{j} = {( {R}_{i}^{j} )}_{0} + \frac{{X}_{0} - {X}_{i}^{j}}{{( {R}_{i}^{j} )}_{0}} dX + \frac{{Y}_{{0}^{-}} {Y}_{i}^{j}}{{( {R}_{i}^{j} )}_{0}} dY + \frac{{Z}_{0} - {Z}_{i}^{j}}{{( {R}_{i}^{j} )}_{0}} dZ + \frac{\partial {T}_{i}^{j}}{\partial {C}_{n m}} {dC}_{n m} + \frac{\partial {T}_{i}^{j}}{\partial {S}_{n m}} {dS}_{n m} + {d ( {t}_{r} )}_{i} - c \cdot {( {t}_{s} )}_{i}^{j} - {ρ}_{i}^{j} \qquad ( 5 )$$
in equation (5), take:
$$\frac{{X}_{0} - {X}_{i}^{j}}{{( {R}_{i}^{j} )}_{0}} = {I}_{i}^{j} , \frac{{Y}_{0} - {Y}_{i}^{j}}{{( {R}_{i}^{j} )}_{0}} = {J}_{i}^{j} , \frac{{Z}_{0} - {Z}_{i}^{j}}{{( {R}_{i}^{j} )}_{0}} = {K}_{i}^{j} ;$$
$$\frac{\partial {T}_{i}^{j}}{\partial {C}_{n m}} = {P}_{n m} ( cos ( {e}_{i}^{j} ) ) cos ( m ( {α}_{i}^{j} ) ) , \\ \frac{\partial {T}_{i}^{j}}{\partial {S}_{n m}} = {P}_{n m} ( cos ( {e}_{i}^{j} ) ) sin ( m ( {α}_{i}^{j} ) ) ;$$
$${P}_{n m} ( cos ( {e}_{i}^{j} ) ) cos ( m ( {α}_{i}^{j} ) ) = {( {A}_{n m} )}_{i}^{j} , {P}_{n m} ( cos ( {e}_{i}^{j} ) ) sin ( m ( {α}_{i}^{j} ) ) = {( {B}_{n m} )}_{i}^{j} ;$$
where Iᵢ^{j} represents the coefficient of the parameter dX calculated from the approximate coordinate of the station and coordinate of the satellite j at epoch i, the parameter dX is the correct value of the approximate coordinate X₀ of the station; Jᵢ^{j} represents the coefficient of the parameter dY calculated from the approximate coordinate of the station and coordinate of the satellite j at epoch i, the parameter dY is the correct value of the approximate coordinate Y₀ of the station; Kᵢ^{j} represents the coefficient of the parameter dZ calculated from the approximate coordinate of the station and coordinate of the satellite j at epoch i, the parameter dZ is the correct value of the approximate coordinate Z₀ of the station; (Aₙₘ)ᵢ^{j} represents the coefficient of the parameter Cₙₘ of the spherical harmonics calculated from the approximate coordinate of the station and coordinate of the satellite j at epoch i; (Bₙₘ)ᵢ^{j} represents the coefficient of the parameter Sₙₘ, of the spherical harmonics calculated from the approximate coordinate of the station and coordinate of the satellite j at epoch i; d(tᵣ)ᵢ represents the parameter for the clock bias of the receiver in the station at epoch i;
the simplified linearization expression for the standard point positioning error equation is shown as equation (6);
(v_{ρ})ᵢ^{j}=Iᵢ^{j}dX+Jᵢ^{j}dY+Kᵢ^{j}dZ+d(tᵣ)+(Aₙₘ)ᵢ^{j}dCₙₘ+(Bₙₘ)ᵢ^{j}dSₙₘ−(w_{ρ})ᵢ^{j} (6)
where i=1, 2, . . . , epoch, epoch represents the maximum epoch number of observations; (w_{ρ})ᵢ^{j} represents the constant term calculated from the pseudo-range of the satellite j at epoch i, the clock bias of the satellite j at epoch i and the euclidean distance between the approximate coordinate of the station and the satellite j at epoch i, wherein, (w_{ρ})ᵢ^{j}=ρᵢ^{j}−(Rᵢ^{j})₀+c·(tₛ)ᵢ^{j};
the sliding window is configured to select epochs in an amount of i and each epoch can observe up to satellites in an amount of j, the pseudo-ranges of all satellites under this sliding window consist of equations in an amount of imax, wherein, imax=i×j;
when the coefficient matrix of the standard point positioning error equation, the vector-matrix of correction number for the pseudo-range, the constant term matrix and the parameter matrix to be estimated are respectively defined as B, V, L, X, then their expressions are respectively shown as:
$$B = [ \begin{matrix}{I}_{1}^{1} & {J}_{1}^{1} & {K}_{1}^{1} & 1 & 0 & ⋯ & 0 & 1 & 0 & ⋯ & 0 & {( {A}_{00} )}_{1}^{1} & {( {A}_{10} )}_{1}^{1} & ⋯ & {( {B}_{NmaxNmax} )}_{1}^{1} \\ {I}_{1}^{2} & {J}_{1}^{2} & {K}_{1}^{2} & 1 & 0 & ⋮ & 0 & 0 & 1 & ⋯ & 0 & {( {A}_{00} )}_{1}^{2} & {( {A}_{10} )}_{1}^{2} & ⋯ & {( {B}_{NmaxNmax} )}_{1}^{2} \\ ⋮ & ⋮ & ⋮ & ⋮ & ⋮ & ⋱ & ⋮ & ⋮ & ⋮ & ⋱ & ⋮ & ⋮ & ⋮ & ⋱ & ⋮ \\ {I}_{2}^{1} & {J}_{2}^{1} & {K}_{2}^{1} & 0 & 1 & ⋯ & 0 & 0 & 0 & 0 & 0 & {( {A}_{00} )}_{2}^{1} & {( {A}_{10} )}_{2}^{1} & & {( {B}_{NmaxNmax} )}_{2}^{1} \\ ⋮ & ⋮ & ⋮ & ⋮ & ⋮ & ⋱ & ⋮ & ⋮ & ⋮ & ⋱ & ⋮ & ⋮ & ⋮ & ⋱ & ⋮ \\ {I}_{imax}^{j} & {J}_{imax}^{j} & {K}_{imax}^{j} & 0 & 0 & … & 1 & 0 & 0 & 0 & 1 & {( {A}_{00} )}_{imax}^{j} & {( {A}_{10} )}_{imax}^{j} & … & {( {B}_{NmaxNmax} )}_{imax}^{j}\end{matrix} ] ;$$
$$V = {[ \begin{matrix}{( {v}_{ρ} )}_{1}^{1} & {( {v}_{ρ} )}_{1}^{2} & ⋯ & {( {v}_{ρ} )}_{2}^{1} & ⋯ & {( {v}_{ρ} )}_{imax}^{j}\end{matrix} ]}^{T} ;$$
$$L = {[ \begin{matrix}- {( {w}_{ρ} )}_{1}^{1} & - {( {w}_{ρ} )}_{1}^{2} & ⋯ & - {( {w}_{ρ} )}_{2}^{1} & ⋯ & - {( {w}_{ρ} )}_{imax}^{j}\end{matrix} ]}^{T} ;$$
X[dX dY dZ (dtᵣ)₁ . . . (dtᵣ) C₀₀ . . . C_{NmaxNmax} S_{NmaxNmax}]^{T};
the linearization expression of the standard point positioning error equation (6) is expressed by one matrix form, as shown by equation (7);
V=BX−L (7)
the least-squares estimation of the unknown parameter X is: X=(B^{T}PB)⁻¹ B^{T}PL (8)
where P is unit weighting matrix;
I.3.2. Judgment is performed to determine whether the coefficient matrix B in judgment equation (7) is ill-conditioned or not, if the judge determines that the coefficient matrix B is ill-conditioned, then step I.3.3 is executed; otherwise, if the coefficient matrix B is determined as well-conditioned, the step I.3.4 is executed;
I.3.3. firstly providing an initial value of an undetermined and unknown parameter X for the corrected iteration of the least-squares spectrum by using the truncated singular value decomposition method, then calculating the value of the unknown parameter X based on the corrected iteration of the least-squares spectrum;
it is assumed that the coefficient matrix B∈R^{n×m}, R^{n×m} represents the real matrix of n rows and m columns; then the singular value decomposition of the coefficient matrix B is:
B=USV^{T} (9)
where U∈n×n, V∈m×m, U and V are all orthogonal matrixes, S E n×m is a diagonal matrix;
the truncated singular value matrix Bₖ of the coefficient matrix B∈R^{n×m} is defined as:
$${B}_{k} ≡ {US}_{k} {V}^{T} = {\sum }_{i = 1}^{k} {u}_{i} {σ}_{i} {v}_{i}^{T} , {S}_{k} = diag ( {σ}_{1} , {σ}_{2} , ⋯ , {σ}_{k} , 0 , ⋯ 0 ) ∈ {R}^{n \times m} \qquad ( 10 )$$
where the smallest (r−k) nonsingular value in the matrix S is replaced with zero, i.e., are truncated, wherein k≤r; r represents the rank of the coefficient matrix B, k represents the number of singular values retained in the matrix S;
uᵢ represents the vector corresponding to the matrix U, vᵢ represents the vector corresponding to the matrix V, σᵢ represents the singular value retained in the matrix S;
calculating the mean value of singular values in the matrix S and taking this mean value as the threshold value of the truncated singular values, wherein, in the matrix S, values greater than the truncated singular values are retained and values less than the truncated singular values are processed zero out;
the truncated singular value solution \hat{X}_{TSVD}^{(k)} in equation (7) is:
$${\hat{X}}_{TSVD}^{( k )} ≡ {A}_{k}^{+} L = {\sum }_{i = 1}^{k} \frac{〈 {u}_{1} , L 〉}{{σ}_{i}} {v}_{i} \qquad ( 11 )$$
where Aₖ⁺=VSₖ⁺U^{T} Sₖ⁺=diag(σ₁⁻¹, σ₂⁻¹, . . . , σₖ⁻¹, 0, . . . 0)∈R^{n×m};
according to the least-squares principle V^{T}PV=min, equation (8) is written as follow:
(B^{T}PB)X=(B^{T}PL) (12)
the left and right of the equation of equation (12) are both added with the unknown parameter KX, which is simplified to obtain equation (13);
(B^{T}PB+KI)X=B^{T}PL+KX (13)
equation (13) is sorted up into the corrected iteration equation of the least-squares spectrum is:
X=(B^{T}PB+KI)⁻¹(B^{T}PL+KX) (14)
where K is any real number;
the solution to the unknown parameter X is obtained based on the corrected iteration of the least-squares spectrum, then go to step I.3.5;
I.3.4. the solution to the unknown parameter X is obtained by using the least square method, then go to step I.3.5;
I.3.5. the parameter values contained in the unknown parameter X, i.e., the location parameters (dX, dY, dZ) of the station, the clock bias dtᵣ of the receiver and the coefficients Cₙₘ and Sₙₘ of the spherical harmonics, are obtained based on the calculated solution of the unknown parameter X;
the location parameters (dX, dY, dZ) contained in the unknown parameter X are respectively introduced to the approximate coordinate (X₀, Y₀, Z₀) of the station to obtain the station coordinate (X,Y,Z) under the earth-centered earth-fixed coordinate system calculated by the standard point positioning;
I.3.6. the station coordinate are transformed from the earth-centered earth-fixed coordinate system to the local Cartesian coordinate coordinate system to achieve GNSS standard point positioning.

2. The GNSS standard point positioning method based on spherical harmonics according to claim 1, characterized in that,
in the step I.3.2, judgment of determining whether the coefficient matrix B is ill-conditioned or not is performed as follow: calculating the conditional number of the coefficient matrix B in equation (7) and setting the empirical threshold value for the conditional number; the judgment is performed by comparing the conditional number with the empirical threshold value:
when the conditional number is greater than the empirical threshold value, the coefficient matrix B is determined as ill-conditioned, otherwise, the coefficient matrix B is determined as well-conditioned.

3. The GNSS standard point positioning method based on spherical harmonics according to claim 1, characterized in that,
in the step I.3.3, the process of calculating X based on the corrected iteration equation of the least-squares spectrum is as follows:
the calculation of X based on the corrected iteration of the least-squares spectrum includes two iteration processes of iteration \textcircled{1} and iteration \textcircled{2}; wherein, a first comparison threshold value is set to determine whether iteration \textcircled{1} is converged or not and a second comparison threshold value is set to determine whether iteration \textcircled{2} is converged or not;
iteration \textcircled{1}: in the first iteration, the initial value of K is set as 1, the truncated singular value solution \hat{X}_{TSVD}^{(k)} obtained from equation (11) is taken as the initial value of X of equation (14) in the first iteration, which is assigned to Xin the right of equation (14);
in each iteration process, the value of the unknown parameter X obtained in the last iteration from the equation (14) is taken as the initial value of X in the present iteration process, which is assigned to Xin the right of the equation in equation (14);
the value of the unknown parameter Xin each iteration process is calculated based on equation (14);
calculating the difference value between the value of X obtained in each iteration process and the initial value of Xin each iteration;
if the different value obtained from the difference calculation is greater than the first comparison threshold value, it means that the iteration is not converged, which means the value of K in the corrected iteration of the least-squares spectrum needs to be corrected by increasing the value of K by 1, then the above iteration \textcircled{1} process is continued;
if the difference value obtained from the difference calculation is less than equal to the first comparison threshold value, then end the iteration \textcircled{1} and go to the iteration \textcircled{2};
iteration \textcircled{2}: comparing the value of the unknown parameter X obtained from equation (14) with the second comparison threshold value;
if the value of the unknown parameter X obtained from equation (14) is greater than the second comparison threshold value, it means the iteration \textcircled{2} is not converged, at this time, the location parameters (dX, dY, dZ) are respectively added into the approximate coordinate (X₀, Y₀, Z₀) to update the approximate coordinate of the station, by linearizing the standard point positioning error equation with updated approximates coordinate of the station through equation (5) and simplifying the linearized standard point positioning error equation through equation (6), go back to iteration \textcircled{1} to calculate the value of the unknown parameter X;
if the value of the unknown parameter X obtained from equation (14) is less than or equal to the second comparison threshold value, it means the iteration \textcircled{2} is converged, then the iteration is ended; at this time, the value of the unknown parameter X obtained from equation (14) is the solution to the unknown parameter X.

4. The GNSS standard point positioning method based on spherical harmonics according to claim 1, characterized in that,
in the step I.3.4, the process of calculating the unknown parameter X based on the least square method is as follows:
a third comparison threshold value is set to determine whether the iteration is converged or not; in each iteration process, the value of the unknown parameter X by using equation (8), the value of the unknown parameter X obtained in the present iteration is compared with the third comparison threshold value;
if the value of the unknown parameter X obtained from equation (8) is greater than the third comparison threshold value, it means the iteration is not converged, at this time, the location parameter (dX, dY, dZ) are respectively added into the approximate coordinate (X₀, Y₀, Z₀) to update the approximate coordinate of the station, calculation processes of equation (5)-equation (8) are executed to calculate the value of the unknown parameter X again;
if the value of the unknown parameter X obtained from equation (8) is less than or equal to the third comparison threshold value, it means the iteration is converged, then the iteration is ended; at this time, the value of the unknown parameter X obtained from equation (8) is the solution to the undetermined and unknown parameter X.
